(19) United States
(12) Patent Application Publication
(10) Pub. No.: US 2012/0233199 A1
(43) Pub. Date: Sep. 13, 2012

(54) Intelligent Web Caching

(76) Inventor: Jeffrey R. Jenkins, San Jose, CA (US)

(21) Appl. No.: 13/045,424

(22) Filed: Mar. 10, 2011

(51) Int. Cl. G06F 17/30; G06F 15/16

(52) U.S. Cl. 707/769; 707/E17.014

(57) ABSTRACT

Methods and apparatuses that store two or more items in a persistent cache with time stamps indicating similarity of the items are described. In response to receiving a request, one of the items uniquely identified by the request may be retrieved from the persistent cache. The retrieved item may have a time stamp. In one embodiment, additional items may be searched from the persistent cache according to the time stamp. The search may identify the additional items having time stamps similar to the time stamp of the retrieved item. The additional items may be retrieved from the persistent cache and stored in a memory cache to allow faster retrieval of the additional items when requested.

### FIELD OF INVENTION

The present invention relates generally to caching. More particularly, this invention relates to intelligently caching similar web resources for faster retrieval.

### BACKGROUND

With the increase in the popularity of the web (or World Wide Web), the use of browsers (or web browsers) for accessing web pages has become more common. Typically, a web page may be rendered according to multiple components or resources specified in the web page. For example, the web page may be a text document including hypertext markup language (HTML) tags or codes addressing the components, such as fonts, graphic elements and/or other documents, via uniform resource locators (URL) to indicate where the components may be retrieved or downloaded over the Internet. To speed up rendering a web page, a web browser may store previously requested resources in a browser cache on a client device hosting the web browser to avoid repeated downloads.

However, as the complexities of web pages increase, more and more components are required for rendering the web pages. Often, a browser cache, such as a memory based cache, may be too small to store the large number of resources or documents accessed during operations of a browser. Although a disk cache, e.g. based on a mass storage device, may be capable of larger and easily expandable cache capacity, access time to the disk cache may not be fast enough. Besides, well known mechanisms to determine when cached resources must be replaced to make room for newly retrieved ones, such as those based on least recent used (LRU) metric, are usually application neutral and incapable of leveraging how a browser application performs browsing operations. As a result, browser specific metrics to predict likelihood for cached resources of being requested again by the browser application are often ignored.

Therefore, traditional approaches for browser caching do not manage caches intelligently for a browser application to provide satisfactory user experiences.

### SUMMARY OF THE DESCRIPTION

A local cache used in an application, e.g. a browser application, may store remotely retrieved items with additional attributes assigned to facilitate future retrieval by the application. The attributes may indicate similarity of cached items, for example, to increase cache hit ratio. In one embodiment, the attributes may be time stamps capable of indicating that resources requested by the browser application to render a web page are similar to the web page or resources of the web page. The cached items similar to the web page can be identified from the local cache, such as a disk cache, according to the attributes for a future request from the web page. As a result, a memory cache may be intelligently pre-filled with the identified items from the disk cache on receiving the future request for the web page. The memory cache may provide direct and fast access to the cached items likely to be subsequently requested to complete rendering the web page without a need for resource fetches via slower disk (e.g. a mass storage device or a memory which is slower than the memory cache) or network interface operations.

An embodiment of the present invention includes methods and apparatuses that store two or more items in a persistent cache with time stamps and these time stamps can be used to indicate similarity of the items. In response to receiving a request, one of the items uniquely identified by the request may be retrieved, before they are requested, from the persistent cache. In one embodiment, additional items may be searched from the persistent cache according to a time stamp of the retrieved item. The search may identify the additional items having time stamps similar to the time stamp of the retrieved item. The additional items may be retrieved from the persistent cache and stored in a memory cache to allow faster retrieval or low-latency when requested.

In another embodiment, in response to a first request for a web page, components (or elements) of the web page may be retrieved from one or more web servers. Time stamps may be assigned to the components stored in a persistent cache to indicate that the web page and the components are retrieved substantially simultaneously (or concurrently) with the first request. Subsequently, in response to a second request for the web page, the web page (or components of the web page) with a particular time stamp may be retrieved from the persistent cache. Additional components with time stamps similar to the particular time stamp may be identified from the persistent cache (e.g. via a search). A memory cache may be populated with the additional components identified from the persistent cache to allow faster retrieval of the additional components for possible future requests.

In yet another embodiment, in response to a request uniquely addressing a resource, a first cache may be queried for the resource using a first criteria based on the request. A second cache for the resource may be queried using the first criteria if the query to the first cache fails. The first cache may be capable of faster access than the second cache. An attribute associated with the resource may be identified in the second cache. In one embodiment, the attribute may be independent of the first criteria. The second cache may be queried to identify additional resources using a second criteria based on the attribute. The additional resources identified from the second cache may be speculatively populated to the first cache to allow faster retrieval of the additional resources when these additional resources are requested in the future.

Other features of the present invention will be apparent from the accompanying drawings and from the detailed description that follows.

### BRIEF DESCRIPTION OF THE DRAWINGS

The present invention is illustrated by way of example and not limitation in the figures of the accompanying drawings, in which like references indicate similar elements and in which:

FIG. 1 is a block diagram illustrating one embodiment of intelligent caching for web resources;

FIG. 2 is a block diagram illustrating an exemplary system to enable multi-level caching;

FIG. 3 is a flow diagram illustrating one embodiment of a process to store items retrieved from a persistent cache to a memory cache for faster retrieval;

FIG. 4 is a flow diagram illustrating one embodiment of a process to cache resources based on time stamps;

FIG. 5 is a flow diagram illustrating one embodiment of a process to query a first cache for similar items to speculatively populate a second cache;

FIG. 6 illustrates one example of a data processing system such as a computer system, which may be used in conjunction with the embodiments described herein.

### DETAILED DESCRIPTION

Methods and apparatuses for intelligent web caching are described herein. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

The processes depicted in the figures that follow, are performed by processing logic that comprises hardware (e.g. circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

In one embodiment, performance for loading a web resource (e.g. a web page, a hypertext document, or other applicable retrievable data) uniquely addressed by a URL (universal resource locator) in a request may improve significantly with high likelihood or possibility of memory cache hit without a need for disk IO or network transaction operations. The memory cache may be pre-filled or speculatively filled with resources relevant to a single resource, such as an original web page, retrieved for an original request to increase a cache hit rate for subsequent requests caused via processing (e.g. parsing, rendering etc.) the single resource. Relevancy between two resources may be heuristically determined based on a similarity measure independent of content inside the resources and/or corresponding requests. A performance increase of 10% to 15% may be possible when pre-filling the memory cache with the relevant resources (e.g. compared with a technique using the memory cache without pre-filling).

For example, a URL loading system, e.g. associated with a web browser application, can make heavy use of caches to store data loaded or requested from web servers to enable serving subsequent requests directly from the caches instead from network connections and/or file system interfaces. In addition to looking for an item (or resource) based on a request from the caches, the loading system may search, e.g. concurrently in the background, for additional items similar to the requested item from a slow cache (e.g. a hard disk or other persistent storage device) and pre-fill a fast cache with the similar items with high likelihood of being subsequently requested, e.g. from the web browser application. In one embodiment, the pre-filling (or storing) of the additional items may occur before the web browser issues requests for the stored items from the URL loading system. Similarity, correlation or other applicable relationships between the items may be measured using attributes, such as time stamps, assigned to the items indicating when the items were requested, retrieved, stored, or operated on by an application.

In one embodiment, these time stamps assigned to the items can be different from and independent of any time stamp assigned by a file system software which maintains the disk directory or other directory of the file system; the time stamps assigned by such file system software may indicate a date/time of creation of modification (or both) of a file in the file system. Examples of such file system software may include the Finder, which provides a graphical user interface (GUI) for the file system software on a Macintosh computer and Windows Explorer on a Windows PC computer. In certain embodiments, a fast cache may be a memory cache (e.g. system DRAM) accessible directly via in-memory operations without requiring disk IO nor network interface operations. In comparison, a slow cache may be a disk cache (e.g. a hard disk or other persistent storage device) requiring IO operations (e.g. disk IO or network IO) for access.

In one embodiment, a browser application may retrieve a resource (e.g. a web page) from a web server via a request and cache the response (e.g. including the originating request) and the corresponding resource (or original resource) in a persistent cache, such as a database. The resource may include a tree-like structure linking additional resources, e.g. an HTML document including three image tags for three images, to cause the browser application to issue subsequent requests to acquire the additional resources substantially immediately (or around the same time) as the resource is retrieved or requested. In some embodiments, the resource originally retrieved and the additional resources, based on requests of the same or different domains, may be stored in a persistent cache, such as a database or disk files, with time stamps indicating similar times to when the resource was originally received or when the request was originally issued.

Subsequently, for example, in response to a request for a web page associated with a time stamp stored in a persistent cache, a memory cache may be populated (or heated up) with multiple items retrieved from the persistent cache with similar time stamps to the time stamp of the web page. These items may be maintained (or kept hot) in the memory cache to increase the likelihood of serving subsequent requests generated from the web page directly from the memory cache which requires much less time to access than the persistent cache does. In some embodiments, a stale item may be removed (or filtered) from or not stored in the cache according to, for example, policies specified based on HTTP (hypertext transport protocol) protocol.

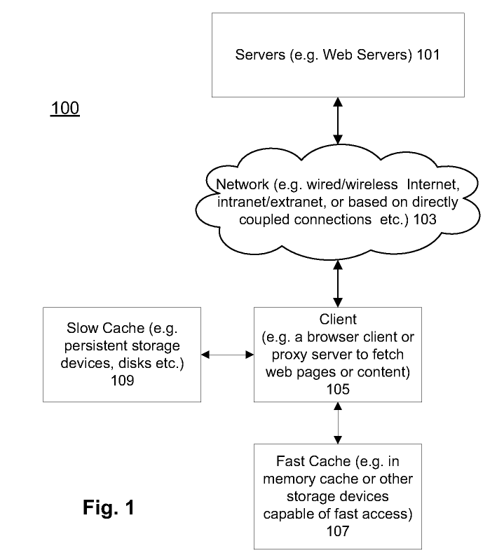

FIG. 1 is a block diagram illustrating one embodiment of intelligent caching for web resources according to one embodiment described herein. Networked systems 100 may include one or more servers 101, e.g. based on web servers, coupled to one or more clients, such as client 105, via networks 103, which may include wired/wireless networks, Internet, intranet/extranet or other combinations of networks. In one embodiment, network 103 may be configured as direct connections between devices.

Client 105 may be a browser application or other applications running in a client device to retrieve resources (e.g. web pages or content) from server 101. Alternatively, client 105 may be a proxy application hosted in a proxy server. In one embodiment, client 105 may be coupled with a multiple cache devices, such as fast and slow caches 107, 109, with different access speeds and/or sizes. For example, fast cache 107 may be an in memory cache having a faster access speed when compared with slow cache 109 based on a persistent storage, such as a mass storage device or a disk. Client 105, fast cache 107 and slow cache 109 may be configured in a single device or among multiple devices.

In one embodiment, client 105 may fetch a web page addressed by a URL requested (e.g. via a user interface). Client 105 may query fast cache 107 using the URL for the web page. Optionally, client 105 may also query slow cache 109 using the same URL if the query to fast cache 107 fails. If the web page is not cached in fast cache 107 nor slow cache 109, client 105 may retrieve the web page directly from server 101, e.g. remotely via network transactions based on HTTP protocols. The retrieved web page (or an element of the web page) may be assigned a time stamp and cached in fast cache 107 and/or slow cache 109. The time stamp may indicate approximately when the web page (or an element of the web page) is requested and/or received. This time stamp can be stored in a database maintained by the web browser and this database, with its time stamps, can be independent of any file system database maintained by a file system software such as the Finder on a Macintosh computer. Client 105 may retrieve additional resources, such as images, scripts, and executables etc., required for rendering the web page substantially right after receiving the web page. In one embodiment, client 105 may assign time stamps to the additional resources retrieved and store these resources in fast cache 107 and/or slow cache 109, subject to, for example, cache size limitations. The time stamps of these additional resources may be similar to the time stamp assigned to the web page.

For example, the similarity can be determined from a difference in time between two or more time stamps. In one embodiment, if two time stamps are within 1 second, 5 seconds or some other short period of time, then they are considered similar enough to cause the additional resources to be speculatively populated (e.g. stored) into the fast cache even before the additional resource is requested by the web page.

Subsequently, client 105 may receive another request with the URL addressing the web page as previously cached. Client 105 may retrieve the web page associated with the time stamp from fast cache 107 or slow cache 109 (e.g. local caches). Concurrently in the background, e.g. when processing the web page retrieved from a local cache, client 105 may search slow cache 109 to identify cached items with time stamps similar to the time stamp of the web page. In one embodiment, the identified cache items may include resources specified in the web page for rendering the web page. Client 105 may push the identified items, e.g. along with associated time stamps, to fast cache 107. Meanwhile, client 105 may have processed the web page and send requests for additional resources required, which may highly likely be included in the identified items already pushed into cache 107. As a result, client 105 may directly retrieve a majority of the additional resources required from cache 107 without accessing either cache 109 or server 101.

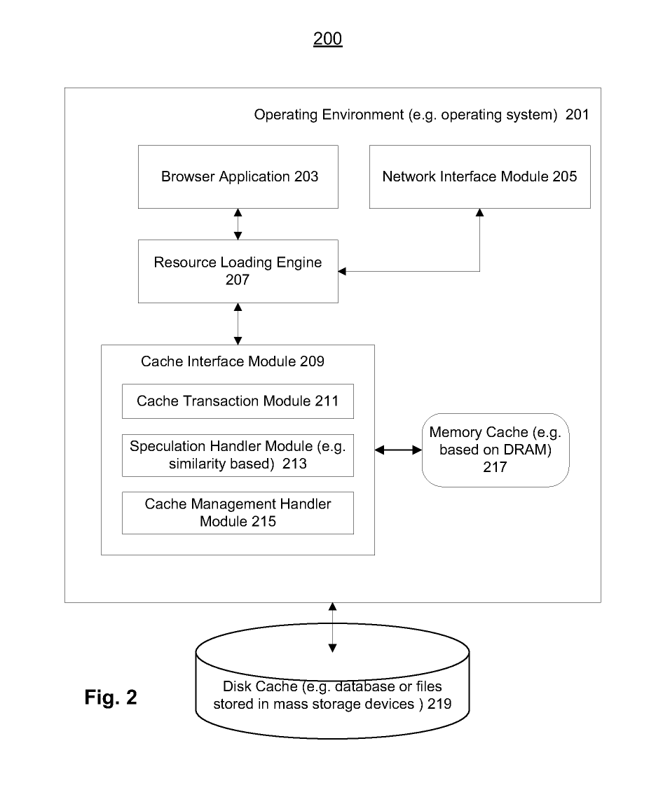

FIG. 2 is a block diagram illustrating an exemplary system to enable multi-level web caching based on similarity according to one embodiment described herein. In one embodiment, system 200 may be a client device running an operating environment 201 hosting a client, such as client 105 FIG. 1. System 201 may include a browser application 203 which may be a standard browser application, e.g. Safari from Apple Inc. of Cupertino, Calif., Internet Explorer from Microsoft of Redmond, Wash., or other applicable browsers, capable of retrieving and rendering web content based on standard specifications, such as HTML, HTTP, or other applicable specifications.

In one embodiment, application 203 may request a web resource, such as a hypertext document, a multimedia content, an executable binary, a script file, or other applicable resource uniquely addressed by a URL. Application 203 may forward a request including an URL addressing the web resource to resource loading engine 207, for example, according to a user request received from a user interface of system 201. To improve retrieval performance, resource loading engine 207 may locate the web resource from local caches, such as memory cache 217 and/or disk cache 219 prior to loading the web resource remotely from a web server, such as server 101 of FIG. 1. Loading engine 207 may access local caches via cache interface module 209 (e.g. based on URLs). If the web resource requested cannot be found in local caches, in one embodiment, loading engine 207 may retrieve it from a web server via network interface module 205 which performs network transactions, such as based on HTTP protocols, with the web server. Loading engine 207 may forward web resources retrieved from web servers to cache interface module 209 to store remotely retrieved resources in local caches.

Memory cache 217, e.g. based on fast cache 107 of FIG. 1, and disk cache 219, e.g. based on slow cache 109 of FIG. 1, may provide multi-level caching support for increasing resource loading speed in resource loading engine 207. Memory cache 217 may differ from disk cache 219 in access speed. For example, memory cache 217 may be allocated within or close to a memory storing executable codes for application 203 and/or resource loading engine 207. Thus, loading engine 207 may access memory cache 217 directly without performing disk IO operations, which may require extra access time. Disk cache 219, on the other hand, may be based on disk files or a database which can be configured with a larger capacity than memory cache 217 in a cost effective manner (e.g. lower cost for per unit size of memory). In one embodiment, data stored in disk cache 219 may be persistent to survive process life cycles in system 201 and/or device shutting down and restarting. However, loading engine 207 may need to access disk cache 219 via IO operations.

In one embodiment, cache interface module 209 may include cache transaction module 211 capable of performing transactions to local caches, such as memory cache 217 and disk cache 219. Cache transaction module 211 may insert a web resource originally retrieved via network interface module 205 into local caches. Alternatively, cache transaction module 211 may retrieve cached web resources as instructed by resource loading engine 207 based on requests received from, for example, browser application 203. Transactions to local caches may include querying, updating, retrieving, inserting, or other operations supported by the local caches based on a variety of criteria according to how resources are indexed or stored in the local caches. For example, a web resource corresponding to a unique URL may be stored in the local caches with an index generated by a hash of the URL. Optionally, additional attributes, such as time stamps, client domains, user IDs, or other applicable attributes may be assigned as meta data or additional indices associated with the web resource in the local caches. These attributes may be related to how a corresponding web resource is used (e.g. requested, applied, etc.) and may be independent of the unique URL addressing the web resource.

Cache interface module 209 may include speculative handler module 213 capable of assigning additional attributes to a resource for storing, e.g. via cache transaction module 211, the resource in local caches, such as memory cache 217 and/or disk cache 219. The resource may be associated with the assigned attributes together with a corresponding request, such as an HTTP request including a URL identifying the resource. Similarity between different cached resources may be measured according to associated attributes. For example, the assigned attributes may include time stamps and two cached resources may be similar to each other according to a similarity measure based on time if the difference between two corresponding time stamps is less than a certain threshold value (e.g. within a configured range, such as one second). In some embodiments, similarity measured (e.g. a similarity measure) between two resources may be multi-dimensional involving multiple attributes for each resource. Speculative handler module 213 and/or local caches may be configured with similarity measures for generating a similarity indicator (e.g. a number) based on measuring functions of assigned attributes for the resources.

In one embodiment, speculative handler module 213 may perform look ahead or pre-filling operations between local caches in response to a resource retrieved from one of the local caches, e.g. via cache transaction module 211. Speculative handler module 213 may perform the look ahead operations based on the resource concurrently and/or in the background (e.g. based on multiple processes or threads) as cache interface module 209 returns the resource retrieved from local caches to resource loading engine 207. For example, cache transaction module 211 may retrieve the resource from disk cache 219 based on a URL requested from resource loading engine 207. Speculative handler module 213 may query, e.g. based on the URL, disk cache 219 for a time stamp or other attributes associated with the resource. Alternatively, cache transaction module 211 may perform transaction operations to retrieve the resource together with the time stamp or associated attributes from disk cache 219.

In one embodiment, speculative handler module 213 may instruct cache transaction module 211 to search disk cache 219 for resources similar to a resource already retrieved from disk cache 219 based on a similarity measure using a time stamp or other attributes associated with the retrieved resource. Cache transaction module 211 may previously retrieve the resource using a criteria based on a URL corresponding to the retrieved resource. In one embodiment, cache transaction module 211 may use other criteria, such as similarity of time stamps, independent of the URL corresponding the retrieved resource, to search for the resources similar to the retrieved resource. As the similar resources are identified from disk cache 219, speculative handler module 213 may instruct cache transaction module 211 to insert the identified similar resources to memory cache 217. As a result, cache interface module 209 may serve future requests caused by the retrieved resource using the URL based criteria, such as those generated by browser application 203 parsing or processing the retrieved resource corresponding to the URL as request, directly from memory cache 217.

In one embodiment, cache management handler module 215 may be configured with polices to maintain available memory space in local caches, such as memory cache 217 and disk cache 219, due to limited physical memory sizes of the local caches. Cache management handler module 215 may determine which cached resources to remove from the local cache to make room for newly received resources. For example, cache interface module 209 may store a resource forwarded from resource loading engine 207 to memory cache 217. As time passes, memory 217 may fill up to trigger management handler module 215 to retire certain cached resources from memory cache 217, e.g. based on LRU (least recent used) metric, age based, size based or other applicable policies. In one embodiment, selected resources to retire from memory cache 217 may be moved to disk cache 219, which may be of larger capacity than memory cache 217. Disk cache 219 may be pruned following similar or different policies. For example, a resource may be removed from disk cache 219 without copying back to other local caches. In one embodiment, cache management handler module 215 may cause resources to move from memory cache 217 to disk cache 219. Alternatively, speculative handler module 213 may move the resources from disk cache 219 back to memory cache 217 to rebuild memory cache 217 to maintain high cache hit rate or low request latency.

In one embodiment, cache interface module 209 may be capable of identifying whether an item needs to be filtered before the item is cached and/or when the item is retrieved from the cache. For example, cache interface module 209 may be configured with policy implementation protocols specifying when an item or resource remotely retrieved should and should not be cached (e.g. based on time stamps or time duration) according to HTTP standards, e.g. associated with an HTTP response data associated with the retrieved item. Thus, cache interface module 209 may selectively move cached items from a persistent cache, such as disk cache 219, to a memory cache, such as memory cache 217, depending on whether the cached items are still valid at the time of moving.

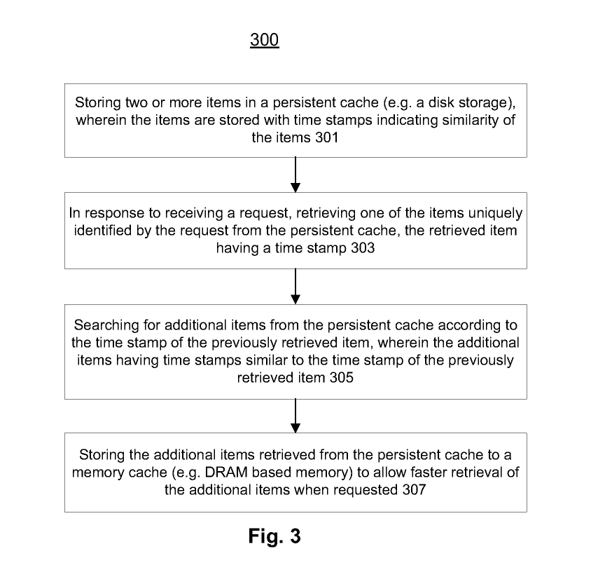

FIG. 3 is a flow diagram illustrating one embodiment of a process to store items retrieved from a persistent cache to a memory cache for faster retrieval according to one embodiment described herein. Exemplary process 300 may be performed by a processing logic that may comprise hardware (circuitry, dedicated logic, etc.), software (such as is run on a dedicated machine), or a combination of both. For example, process 300 may be performed by some components of system 200 of FIG. 2. At block 301, the processing logic of process 300 may store two or more items in a persistent cache, such as disk cache 219 of FIG. 2. Each item may be a web resource originally loaded or retrieved from, for example, a remote web server according to a URL based request from an application, such as a browser. In one embodiment, each item may be assigned with time stamps stored in the persistent cache. A time stamp associated with a cached item retrieved according to a request may indicate substantially when the request occurred, when the item was retrieved and/or when the item was cached. Separate items cached within a configured time range may be determined to be similar to each other according to the associated time stamps. In one embodiment, these time stamps can be different from and in addition to any time stamps maintained by a file system software.

At block 303, in response to receiving a new URL based request, e.g. originated from a browser application, the processing logic of process 300 may retrieve an item from a persistent cache, for example, if the requested item cannot be found in a memory cache. The processing logic of process 300 may attempt to locate the requested item from the memory cache prior to consulting the persistent cache. The retrieved item may be associated with a time stamp. At block 305, in one embodiment, the processing logic of process 300 may search for additional items in the persistent cache according to a similarity measure relative to the retrieved item (e.g. item retrieved in block 303) associated with the new URL based request. In one embodiment, the search may identify the additional items having time stamps similar to the time stamp of the retrieved item. At block 305, the processing logic of process 300 may store the additional items identified from the persistent cache to a memory cache (e.g. based on DRAM), such as memory cache 217 of FIG. 2, to allow faster retrieval of the additional items when requested.

In other embodiments, the processing logic of process 300 may receive a request and, in response, retrieve an item uniquely identified by the request from a persistent cache storing items with time stamps. The time stamps may be used to determine a similarity in time for the items. The retrieved (or original) item may be stored in the persistent cache with a first time stamp. The processing logic of process 300 may search for an additional item from the persistent cache according to the first time stamp. The additional item may be stored in the persistent cache with a second time stamp. The first and second time stamps may indicate the similarity in time between the original item and the additional item. Subsequently, the processing logic of process 300 may store the additional item retrieved from the persistent cache to a memory cache to allow faster retrieval of the additional item when requested in the future.

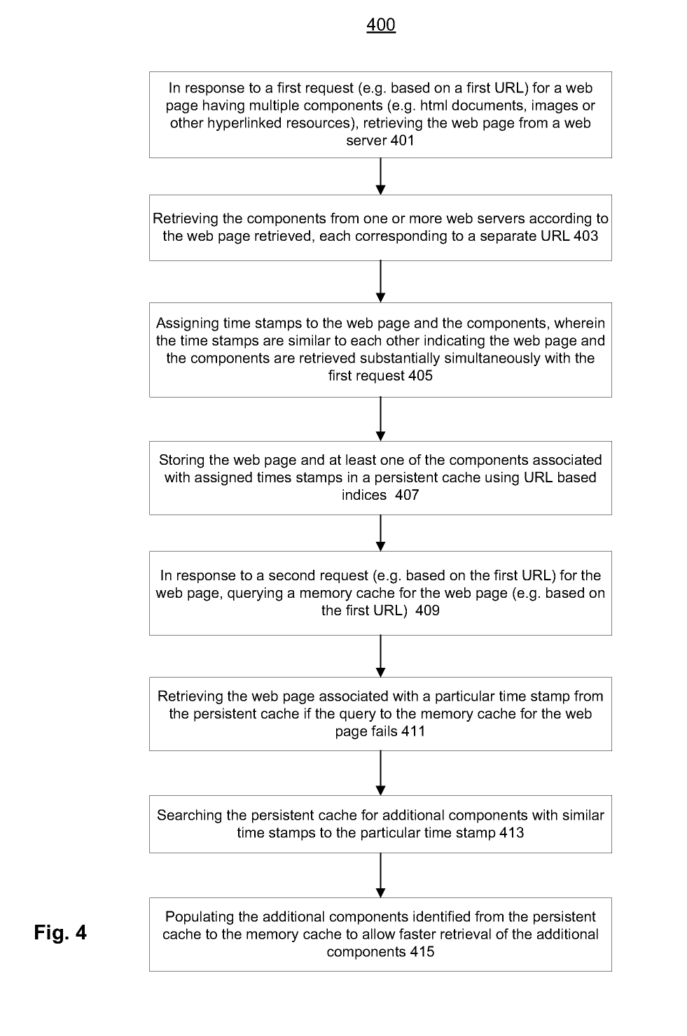

FIG. 4 is a flow diagram illustrating one embodiment of a process to cache resources based on time stamps to improve loading of a requested web page according to one embodiment described herein. Exemplary process 400 may be performed by a processing logic that may comprise hardware (circuitry, dedicated logic, etc.), software (such as is run on a dedicated machine), or a combination of both. For example, process 400 may be performed by some components of system 200 of FIG. 2. At block 401, the processing logic of process 400 may retrieve a web page addressed in a first request (e.g. based on a first URL). The web page may specify multiple components, such as HTML documents, images, scripts or other hyperlinked resources. A browser application may render the web page to display these components in one display page.

At block 403, in one embodiment, the processing logic of process 400 may retrieve components specified in a retrieved web page from one or more web servers. For example, a browser application may process or parse the web page to issue separate requests (e.g. based on separate URLs) addressing the components in the web servers. At block 405, the processing logic of process 400 may assign time stamps or other applicable attributes to the web page and the components. The time stamps may be independent of URLs in the corresponding URL requests. In one embodiment, the time stamps assigned may be similar to each other indicating the web page and the components are retrieved substantially simultaneously with the first request. The processing logic of process 400 may store the web page and at least one of the components associated with the assigned times stamps in a persistent cache, such as disk cache 219 of FIG. 2, using URL based indices generated from corresponding URL requests for the web page and the components. Optionally or alternatively, the retrieved web page and/or the components may be stored in a memory cache or another cache device with faster access time than the persistent cache.

Subsequently at block 409, the processing logic of process 400 may receive a second request, for example, based on the same URL as in a first request previously received. In response, the processing logic of process 400 may query a memory cache to request for a web page indexed by the URL. If the query is successfully, the requested web page may be served directly from the memory cache, for example, to a browser application which issued the second request. Alternatively, if the query to the memory cache fails, the processing logic of process 400 may query a persistent cache to retrieve the web page associated with a particular time stamp from the persistent cache at block 411.

In one embodiment, at block 413, the processing logic of process 411 may search a persistent cache for additional components using a particular time stamp associated with a web page retrieved from the persistent cache. For example, the processing logic of process 400 may query the persistent cache for additional components associated with time stamps similar to the particular time stamp of the web page retrieved. Time stamps can be considered similar when their difference in time is relatively short (e.g. less than 1 second, less than 5 seconds, less than 10 seconds or some other short period of time). Attributes other than time stamps may be applicable for the query to identify the additional components. The web page retrieved may cause additional requests for components associated with the web page, such as based on a browser parsing the web page to retrieve associated components for rendering the web page. In some embodiments, it may be highly likely that the components associated with the web page largely overlap (e.g. based on common URL based requests) with the additional components cached in the persistent cache with time stamps similar to the time stamp of the web page. The processing logic of process 400 may populate the additional components identified from the persistent cache to the memory cache at block 415. As a result, subsequent requests of the second request for the web page retrieved from the persistent cache may cause a high rate of cache hit against the memory cache caching the additional components for faster retrieval or serving responding to the subsequently received requests.

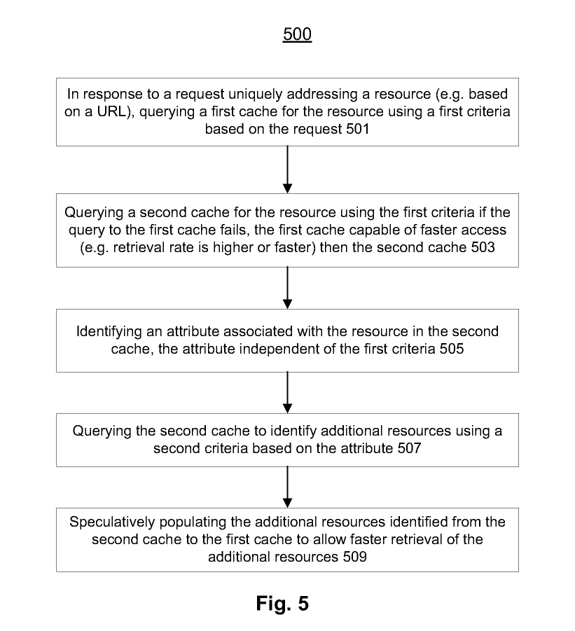

FIG. 5 is a flow diagram illustrating one embodiment of a process to query a first cache for similar items to speculatively populate a second cache according to one embodiment described herein. Exemplary process 500 may be performed by a processing logic that may comprise hardware (circuitry, dedicated logic, etc.), software (such as is run on a dedicated machine), or a combination of both. For example, process 500 may be performed by some components of system 200 of FIG. 2. At block 501, the processing logic of process 500 can query a first cache, e.g. memory cache 217 of FIG. 2, for a resource in response to a request uniquely addressing the resource (e.g. based on a URL). The query may be based on a first criteria including matching an index generated from an address (e.g. a URL) of the resource specified in the request.

At block 503, the processing logic of process 500 may query a second cache, e.g. disk cache 219 of FIG. 2, for a resource using a first criteria if a previous query to a first cache fails. In one embodiment, the first cache may be capable of faster access then the second cache. If the resource is found from the second cache using the first criteria, the processing logic of process 500 may identify an attribute associated with the resource in the second cache. In one embodiment, the attribute, e.g. a time stamp, may be separate from and/or independent of the first criteria, e.g. based on a URL. Subsequently at block 507, the processing logic of process 500 may query the second cache to identify additional resources using a second criteria based on the attribute. Future requests immediately or substantially immediately following a response returning the requested resource (e.g. a browser application using the response to render the resource) may correspond to the additional resources as intelligently identified based on the attribute. The processing logic of process 500 may speculatively populate the additional resources identified from the second cache to the first cache to allow faster retrieval of the additional resources at block 509.

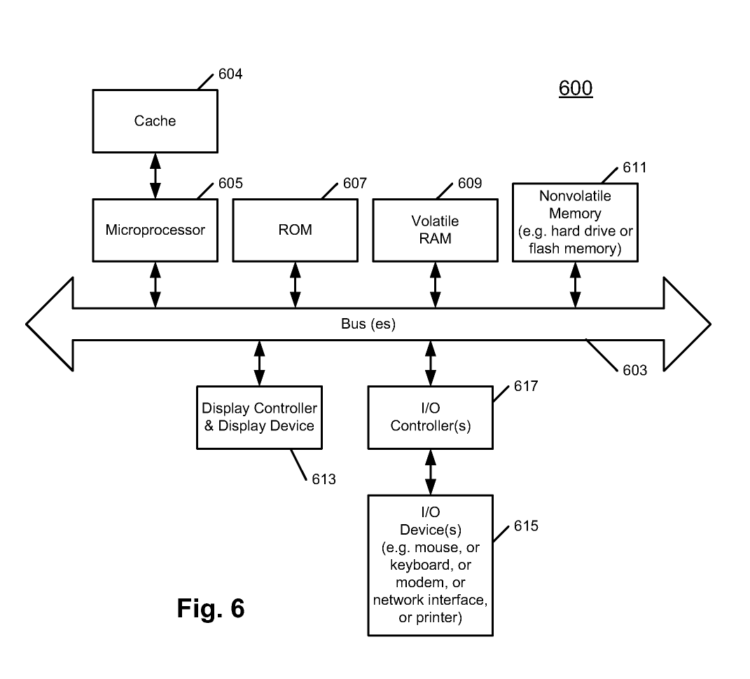

FIG. 6 shows one example of a data processing system such as a computer system, which may be used with one embodiment in the present invention. For example, the system 600 may be implemented as a part of the system shown in FIG. 1. Note that while FIG. 6 illustrates various components of a computer system, it is not intended to represent any particular architecture or manner of interconnecting the components as such details are not germane to the present invention. It will also be appreciated that network computers and other data processing systems which have fewer components or perhaps more components may also be used with the present invention.

As shown in FIG. 6, the computer system 600, which is a form of a data processing system, includes a bus 603 which is coupled to a microprocessor(s) 605 and a ROM (Read Only Memory) 607 and volatile RAM 609 and a non-volatile memory 611. The microprocessor 605 may retrieve the instructions from the memories 607, 609, 611 and execute the instructions to perform operations described above. The bus 603 interconnects these various components together and also interconnects these components 605, 607, 609, and 611 to a display controller and display device 613 and to peripheral devices such as input/output (I/O) devices which may be mice, keyboards, modems, network interfaces, printers and other devices which are well known in the art. Typically, the input/output devices 615 are coupled to the system through input/output controllers 617. The volatile RAM (Random Access Memory) 609 is typically implemented as dynamic RAM (DRAM) which requires power continually in order to refresh or maintain the data in the memory.

The mass storage 611 is typically a magnetic hard drive or a magnetic optical drive or an optical drive or a DVD RAM or a flash memory or other types of memory systems which maintain data (e.g. large amounts of data) even after power is removed from the system. Typically, the mass storage 611 will also be a random access memory although this is not required. While FIG. 6 shows that the mass storage 611 is a local device coupled directly to the rest of the components in the data processing system, it will be appreciated that the present invention may utilize a non-volatile memory which is remote from the system, such as a network storage device which is coupled to the data processing system through a network interface such as a modem or Ethernet interface or wireless networking interface. The bus 603 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g. an abstract execution environment such as a “virtual machine” (e.g. a Java Virtual Machine), an interpreter, a Common Language Runtime, a high-level language virtual machine, etc.), and/or, electronic circuitry disposed on a semiconductor chip (e.g. “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

An article of manufacture may be used to store program code. An article of manufacture that stores program code may be embodied as, but is not limited to, one or more memories (e.g. one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g. a server) to a requesting computer (e.g. a client) by way of data signals embodied in a propagation medium (e.g. via a communication link (e.g. a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

What is claimed is:

1. A machine-readable non-transitory storage medium having instructions therein, which when executed by a machine, causes the machine to perform a method, the method comprising:
in response to receiving a request, retrieving an item uniquely identified by the request from a persistent cache storing items with time stamps including a first time stamp and a second time stamp, wherein the time stamps are used to determine a similarity in time for the items, and wherein the retrieved item is stored in the persistent cache with the first time stamp; and
searching for at least one additional item from the persistent cache according to the first time stamp, wherein the additional item is stored in the persistent cache with the second time stamp, the first and second time stamps indicating the similarity in time for the item and the additional item, and wherein the additional item retrieved from the persistent cache is stored to a memory cache to allow faster retrieval of the at least one additional item when requested.

2. The medium of claim 1, wherein the items include a particular item, wherein the items were fetched subsequent to a previous request addressing the particular item, the previous request received at a particular time and wherein the similarity is based on temporal relationship to the particular time.

3. The medium of claim 2, wherein the previous request was received by a browser application via a user input substantially at the particular time.

4. The medium of claim 2, wherein at least one of the items is addressed inside the particular item addressed by the particular request.

5. The medium of claim 4, wherein the particular item corresponds to a hypertext document including a hyperlink for the at least one of the items.

6. The medium of claim 1, wherein the time stamps correspond to when the items were stored in a database which is stored in the persistent cache.

7. The medium of claim 1, wherein the items were fetched according to a plurality of requests received from a browser application, the request separately addressing the items, and wherein the time stamps correspond to when the separate requests were received from the browser application.

8. The medium of claim 1, further comprising:
querying the memory cache for the one of the items according to the request, wherein the one of the items is retrieved from the persistent cache if the query fails.

9. The medium of claim 8, wherein the request includes a URL (universal resource locator) addressing the one of the items, and wherein the query of the memory cache and the retrieval from the persistent cache are both based on the URL.

10. The medium of claim 9, wherein the search is based on a time based query including the first time stamp and wherein the time based query is independent of the URL.

11. The medium of claim 9, wherein the search is based on a time based query including the first time stamp and wherein the time based query is independent of the URL.

12. A machine-readable non-transitory storage medium having instructions therein, which when executed by a machine, causes the machine to perform a method, the method comprising:
in response to a first request for a web page having one or more components, retrieving the components from one or more web servers;
assigning time stamps to the components in a persistent cache, the time stamps indicating the web page and the components are retrieved substantially simultaneously with the first request;
in response to a second request for the web page, retrieving the web page from the persistent cache, the web page having a particular time stamp;
searching the persistent cache for additional components with similar time stamps to the particular time stamp; and
populating the additional components from the persistent cache to a memory cache to allow faster retrieval of the additional components.

13. The medium of claim 12, further comprising:
querying the memory cache for the web page based on the first request; and
querying the persistent cache for the web page based on the first request if the query to the memory cache fails, wherein the web page is retrieved from the web servers if the query to the persistent cache fails.

14. The medium of claim 12, wherein the first request includes an address uniquely addressing the web page including at least one address uniquely addressing at least one of the components.

15. The medium of claim 14, wherein the address is an URL (universal resource locator) address.

16. The medium of claim 14, wherein the at least one component is retrieved from one of the web servers according to another request including the at least one address and wherein the first request and the another request are separately requested at similar times.

17. The medium of claim 16, wherein the at least one component is stored with a separate time stamp in the persistent storage, where the separate time stamp and the particular time stamp indicate the similar times.

18. A machine-readable non-transitory storage medium having instructions therein, which when executed by a machine, causes the machine to perform a method, the method comprising:
in response to a request uniquely addressing a resource, querying a first cache for the resource using a first criteria based on the request;
querying a second cache for the resource using the first criteria if the query to the first cache fails, wherein the first cache is capable of faster access than the second cache;
identifying an attribute associated with the resource in the second cache, the attribute being independent of the first criteria;
querying the second cache to identify additional resources using a second criteria based on the attribute; and
populating the additional resources identified from the second cache to the first cache to allow faster retrieval of the additional resources.

19. The medium of claim 18, wherein the additional resources are associated with attributes similar to the first attribute associated with the second criteria.

20. The medium of claim 18, wherein the request includes a URL (Universal Resource Identifier) and wherein the first criteria is based on a match for a hash derived from the URL.

21. The medium of claim 18, wherein the attribute indicates when the response to the request is received.

22. The medium of claim 21, wherein the second criteria is based on a measure of similarity to the attribute.

23. The medium of claim 18, wherein the first cache is limited in size and wherein the first cache is maintained to allocate available capacity according the time stamps.

24. A computer implemented method comprises:
in response to receiving a request, retrieving an item uniquely identified by the request from a persistent cache storing items with time stamps, wherein the time stamps are used to determine a similarity in time for the items, and wherein the retrieved item is stored in the persistent cache with a particular one of the time stamps; and
searching for additional items from the persistent cache according to the particular time stamp, wherein the additional items are stored in the persistent cache with separate time stamps, the particular time stamp and the separate time stamps indicating the similarity in time for the item and the additional items, and wherein the additional items retrieved from the persistent cache are stored to a memory cache to allow faster retrieval of the additional items when requested.

25. A computer system comprising:
a memory storing executable instructions, the memory including a memory cache;
a disk storage capable of storing data persistently, the disk storage including a persistent cache storing two or more items with time stamps capable of indicating whether the items are similar;
a processor coupled to the memory and the disk storage to execute the instructions from the memory, the processor being configured to:
in response to receiving a request, retrieve one of the items uniquely identified by the request from the persistent cache, the retrieved item stored in the persistent cache with a time stamp, and
search additional items from the persistent cache according to the time stamp, wherein the additional items are stored in the persistent cache with separate time stamps, wherein the time stamp and the separate time stamps indicate the additional items are similar to the retrieved item, and wherein the additional items retrieved from the persistent cache are stored to the memory cache to allow faster retrieval of the additional items when requested.
